(19) United States
(12) Patent Application Publication
(10) Pub. No.: US 2006/0117507 A1
(43) Pub. Date: Jun. 8, 2006

(54) Swivel brush

(76) Inventor: Tammy Bennett Carter, Fayetteville, NC (US)

Correspondence Address: Tammy B. Carter, 754 Southview Circle, Fayetteville, NC, 28311, US

(21) Appl. No.: 10/957,661

(22) Filed: Dec. 6, 2004

(51) Int. Cl. A46B 13/02; A61C 17/26

(52) U.S. Cl. 15/23; 320/114; 15/DIG. 1

(57) ABSTRACT

(FIG. 1A) 1—shows a brush head with bristles all the way around it, which rotates. FIG. 1B shows several parts on the “Swivel Brush” handle or arm. (FIG. 1B) 2 is the illustration of the pivotal neck on the toothbrush handle that moves back and forth. (FIG. 1B) 3 is the illustration of the grooves located on the body of the handle that allows for a better grip. (FIG. 1B) 4 is the illustration of the on/off switch located on the handle of the toothbrush. (FIG. 2) 6 is the second toothbrush head of the “Swivel Brush” that gives a second option of usage. It is a dual-rotating brush head that has two rotating brush heads rotating in opposite directions. (FIG. 3) 7 is the third option of the “Swivel Brush” which is called “I-Floss Technology”. This brush head is named so because it is shaped like the letter “I” and has dental floss on both sides. FIG. 4 is an illustration of the charger and has several components. (FIG. 4) 8 is an illustration of the cubbyholes located on the charger. (FIG. 4) 9 is an illustration of the compartment where the “Swivel brush is charged and stored. (FIG. 4) 10 is an illustration of the indicator light located on the charger. (FIG. 4) 11 is an illustration of the cord or adapter that goes from the charger to an outlet.

### FEDERALLY SPONSORED RESEARCH

Not Applicable

### SEQUENCE LISTING OR PROGRAM

Not Applicable

### BACKGROUND

1. Field of Invention

This invention relates to toothbrushes, specifically re-designing the bristles to go all the way around the brush, for the first modification. Secondly, re-designing the bristles to a two-way (dual) bristle system, where there are two bristle heads that rotates simultaneously in opposite directions, and lastly, I-Floss Technology, that allows flossing on both top and bottom teeth at the same time.

2. Description of Prior Art

The toothbrush has taken on many forms throughout the years. The first design being one where the bristles stood still, and the person did all the work. Over the years, new designs were developed, and the toothbrush saw many other options and improvement. One of the more advanced models came with the development of the toothbrush with a rotating head that moved in a circular motion. Many companies used this same type of design, which varied slightly in different models.

The latest design which was developed was a toothbrush that have both rotating bristles and bristles that stand still. This is a very popular design that has been modeled by many companies. The latest of these designs consists of cartoon characters and superheroes on the toothbrushes, as a marketing tool.

Although the present design seems to be very successful and popular, there is yet room for improvements and upgrades from the present design. There were many void years, as far as improvements are concerned, from the very first design. Then, in the last few years, many designs have surfaced, which leaves me to believe that there are yet improvements that can be made, even to the current design. The ultimate goal in this endeavor is to provide a fast, yet more thorough clean, with less effort.

### OBJECTS AND ADVANTAGES

There are several advantages of the design that I'm introducing in this patent.

(a). To provide a more thorough clean by introducing a design that includes bristles the goes all the way around the brush head.

(b). A second toothbrush head that contains two (2) rotating heads that moves simultaneously, but in opposites directions. This is an optional brush head that will provide optimum cleansing by breaking loose plaque and moving it out of the way of the teeth and gums.

(c). A third brush head contains dental floss. I call this “I-Floss Technology because this head is shaped like the letter “I” and has floss on both sides.

(d). This toothbrush also has a flexible elbow that allows it to bend for a better reach.

(e). This toothbrush also has grooves on the body that allows for a better grip.

(f). This toothbrush has a battery compartment that uses rechargeable batteries.

(g). This toothbrush also has a charger that houses the Swivel brush as well as two cubbyholes to hold the other two Swivel brush heads, and an indicator light to let you know the toothbrush is charging.

### SUMMARY

In accordance with the present invention, this invention, The Swivel Brush, comprises of bristles that goes all the way around the brush head, in addition, another brush head that has the dual action of two rotating brush heads that spin in opposite directions, and lastly, “I-Floss Technology that allows flossing on the top and bottom simultaneously. All these items are stored on the charger.

### DRAWINGS

Drawing Figures—(Pt. Abbreviation for the Word Part)

FIG. 1A shows the brush head that has bristles all the way around the brush head, that spins.

FIG. 1B shows the brush handle. The handle has several parts; pt. 2 represents the pivotal arm that moves back and forth, pt. 3 represent the grooves on the handle that allows for a better grip, pt. 4 on the handle represent the on/off switch, pt. 5 represent the battery compartment.

FIG. 2 shows the second brush head, pt. 6, which has two rotating bristles that rotates opposite of each other.

FIG. 3 shows the third brush head, pt. 7, which contains “I-Foss” Technology, meaning the head has an I shaped and has floss on both sides which allows one to floss top and bottom simultaneously.

FIG. 4 shows the charger and its parts. Pt. 8 on the charger represents the cubbyholes where brush heads FIG. 1A and FIG. 2 can be stored. Pt. 9 on the charger represents the place where the brush handle, FIG. 1B, is stored. Pt. 10 on the charger represents the indicator light on the charger that let you know the brush handle is charging. Pt. 11 represents the cord on the charger that plugs into the wall.

### REFERENCE NUMERALS IN DRAWINGS

1 Rotating brush head with bristles all the way around the brush head
2 pivotal arm that moves back and forth
3 grooves on the handle
4 on/off switch
5 battery compartment
6 dual rotating brush heads
7 I-Floss Technology brush head
8 cubbyholes on charger
9 brush handle holder on charger
10 indicator light
11 adapter cord

### DETAILED DESCRIPTION

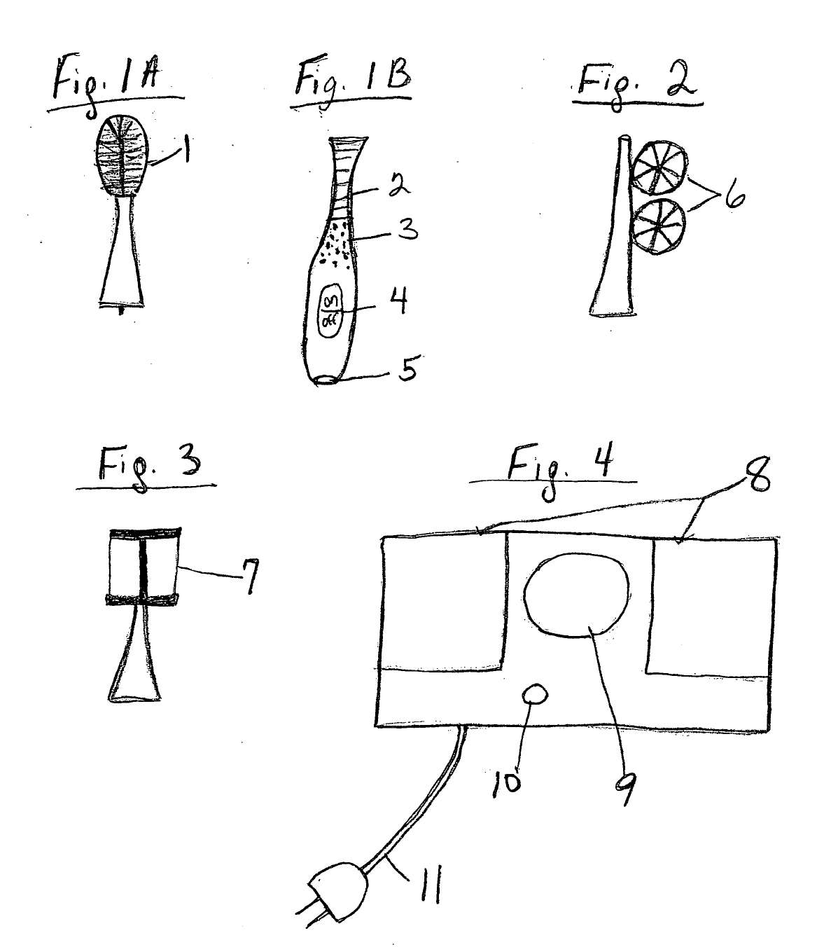

Description—FIGS. 1A and 1B

In (FIG. 1A) 1 is the illustration of the first brush head of The Swivel Brush; which consists of a brush head that has bristles all the way around it and it rotates. In FIG. 1B is the illustration of the brush handle, which has several parts. (FIG. 1B) 2 is an illustration of the pivotal arm that moves back and forth. The arm movement allows for a better reach to clean the back teeth. (FIG. 1B) 3 in the illustration represent the grooves on the handle. The grooves on the handle allows for a better grip, which makes the handle easy to hold and use while brushing. (FIG. 1B) 4 is an illustration of the on/off switch that is located on the handle of the Swivel brush. (FIG. 1B) 5 is an illustration, which represents the battery compartment on the Swivel brush handle. The use of “AA” batteries goes in this compartment.

Description—FIG. 2

In (FIG. 2) 6 is an illustration of the dual rotating brush heads. This brush head has two rotating bristles that rotate simultaneously in opposite directions. This allows for the ultimate clean by breaking up plaque, and sweeping it out of the way, because both bristles are moving in a different direction.

Description—FIG. 3

In (FIG. 3) 7 is the illustration of the third brush head called “I-Floss Technology. This brush head is shaped like the letter “I” and has dental floss on both sides. The shape of this brush head allows a simultaneous cleaning of both the top and bottom teeth.

In FIG. 4 is the illustration of the charger that consists of several parts. (FIG. 4) 8 is an illustration of the cubbyholes that are located on the charger. The purpose of the cubbyholes is to store the additional Swivel brush heads (FIG. 1A & FIG. 2). (FIG. 4) 9 is an illustration of the compartment in which the Swivel brush handle is stored for the purpose of charging. (FIG. 4) 10 is an illustration of the indicator light which is located on the charger. The purpose of the indicator light is to light up when the Swivel brush handle is charging and to go off when the Swivel brush handle is removed.

(FIG. 4) 11 is an illustration of the charger's cord or adapter that goes from the charger to be plugged into the wall.

Operation—FIGS. 1A, 1B, 2, 3, 4

The manner of using “The Swivel Brush” is to first remove it from its charger (FIG. 4)9. The Swivel brush comes with the standard, first Swivel brush head, (FIG. 1A), which is the Swivel brush head that has bristles all the way around, and rotates. The handle has grooves (FIG. 1B) 3 that allows a better grip or handle on the Swivel brush. Also, the Swivel brush reach is improved when moving the pivotal arm of the handle. (FIG. 1B) 2 move it to an angle position. Using the on/off switch on the handle of the Swivel brush turns on the Swivel brush. The Swivel brush has an option of also using (FIG. 2) Dual-rotating bush heads. This option allows you to use a brush head that has two rotating bristles that rotates in opposite directions. This brush head is kept in the cubbyhole on the charger (FIG. 4) 8. Lastly, to complete the brushing process, is the use of “I-Floss Technology, (FIG. 3), on the third brush head. This brush head is shaped like the letter “I” and has dental floss on both sides, which allows you to floss the top and bottom teeth simultaneously. Once the flossing process is done, the Swivel brush is then stored back on the charger (FIG. 4) 9. When the Swivel brush is charging, the indicator light, (FIG. 4) 10, comes on. If the light does not come on, make sure it is plugged properly, (FIG. 4) 11, into an outlet.

### CONCLUSION

The reader will see that the “Swivel Brush” is a great invention and upgrade from the present day toothbrush. This Swivel brush will provide a better clean, and healthier gums and teeth. It provides a variety of options that is guaranteed to satisfy the user by introducing three (3) new heads: 1. Rotating Bristles—that goes all the way around the brush head. 2. Dual-Rotating Brush Heads—that rotates simultaneously, but in opposite directions, and 3. “I-Floss Technology”—allows you to use dental floss on both sides of the “I”, by flossing the top & bottom teeth at the same time.

I Claim:

1. A toothbrush having rotating bristles that goes all the way around the brush head. (Shown in FIG. 1A)

2. A second toothbrush head that have dual rotating brush heads that turn at the same time but in opposite directions. (Shown in (FIG. 2; 6)

3. A third toothbrush head that I call “I-Floss Technology”, because the floss is shaped like the letter I, and is able to floss the top teeth and bottom teeth simultaneously, by having floss at the top and bottom of the “I” shaped head. (Shown in FIG. 3; 7)

4. A flexible elbow on the body of the toothbrush that allows the toothbrush to bend to the left or to the right (Shown in FIG. 1B; 2)

5. A charger that consist of a toothbrush holder, two (2) cubbyholes that will hold the toothbrush and the two additional heads. Also, it has an indicator light to let you know the toothbrush is charging and lastly an adapter to plug into an outlet. (Shown in FIG. 4: 8,9,10,11)

6. Grooves on the body of the toothbrush that allows better gripping. (Shown in FIG. 1B; 3)
